(19) United States
(12) Patent Application Publication
(10) Pub. No.: US 2008/0057775 A1
(43) Pub. Date: Mar. 6, 2008

(54) SATA-INTERFACED HOST BRIDGE DEVICE

(75) Inventor: Sheng-yuan Lin, Taipei City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/845,612

(22) Filed: Aug. 27, 2007

(30) Foreign Application Priority Data
Aug. 29, 2006 (TW) 095215309

(51) Int. Cl. H01R 13/64

(52) U.S. Cl. 439/378

(57) ABSTRACT

A bridge device for SATA-interfaced hosts is provided, including a pair of physical units, a pair of link units, a pair of transmission ports, and at least a bridge unit. Each physical unit provides the connection to a SATA-interfaced host. The link unit links the physical unit and the transmission port, and encodes and decodes the transmitted and received data. The transmission port controls the host-to-device connection, registers, and state of the SATA interface. The bridge unit connects between two transmission ports, and so that the two SATA-interfaced hosts can transmit and receive data. The bridge device of the present invention allows the SATA-interfaced hosts to transmit and receive data and signals at a high speed.

### BACKGROUND OF THE INVENTION

1. Field of the Invention

The present invention relates to a bridge device for SATA-interfaced hosts and, more particularly, to a bridge device for direct connection between two SATA-interfaced hosts for data and signals.

2. The Related Arts

A conventional host-to-host connection for electronic devices is usually done through a USB interface. Although the USB interface provides a popular interface connection, the disadvantage of USB is the bandwidth and the transmission speed. Even with USB2.0 at the transmission speed of 480 Mbps, it is still insufficient for the ever-increasing demands of high speed data or signal transmission between computer hosts. The conventional serial advanced technology attachment (SATA), although having the maximum transmission speed of 3 Gbps, has a transmission structure that is only applicable to host-to-device transmission, instead of host-to-host. All these constraints limit the data and signal transmission between two hosts.

Taiwan Patent Publication No. 390984 disclosed a bridge device between USB-interfaced computers. Taiwan Patent Publication No. M272209 disclosed an improvement of micro hard disk interface that is related to the SATA interface application for the host-to-device. There is no mention of the host-to-host SATA interface devices.

### SUMMARY OF THE INVENTION

An object of the present invention is to provide a bridge device for SATA-interfaced hosts so that the host with SATA interface can communicate directly through the SATA interface for data and signal exchange.

Another object of the present invention is to provide a bridge device for SATA-interfaced hosts so that the hosts can achieve high speed data or signal transmission between hosts.

To achieve the above objects, the present invention provides a bridge device for SATA-interfaced hosts, including a pair of physical units, a pair of link units, a pair of transmission ports, and at least a bridge unit. Each physical unit provides the connection to a SATA-interfaced host. The link unit links the physical unit and the transmission port, and encodes and decodes the transmitted and received data. The transmission port controls the host-to-device connection, registers, and state of the SATA interface. The bridge unit connects between two transmission ports, and so that the two SATA-interfaced hosts can transmit and receive data. The bridge device of the present invention allows the SATA-interfaced hosts to transmit and receive data and signals at a high speed.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 shows a block diagram of a first embodiment of the present invention;

FIG. 2 shows a second embodiment of the present invention;

FIG. 3 shows a third embodiment of the present invention;

FIG. 4 shows a first application of the present invention; and

FIG. 5 shows a second application of the present invention.

### DETAILED DESCRIPTION OF THE PREFERRED EMBODIMENTS

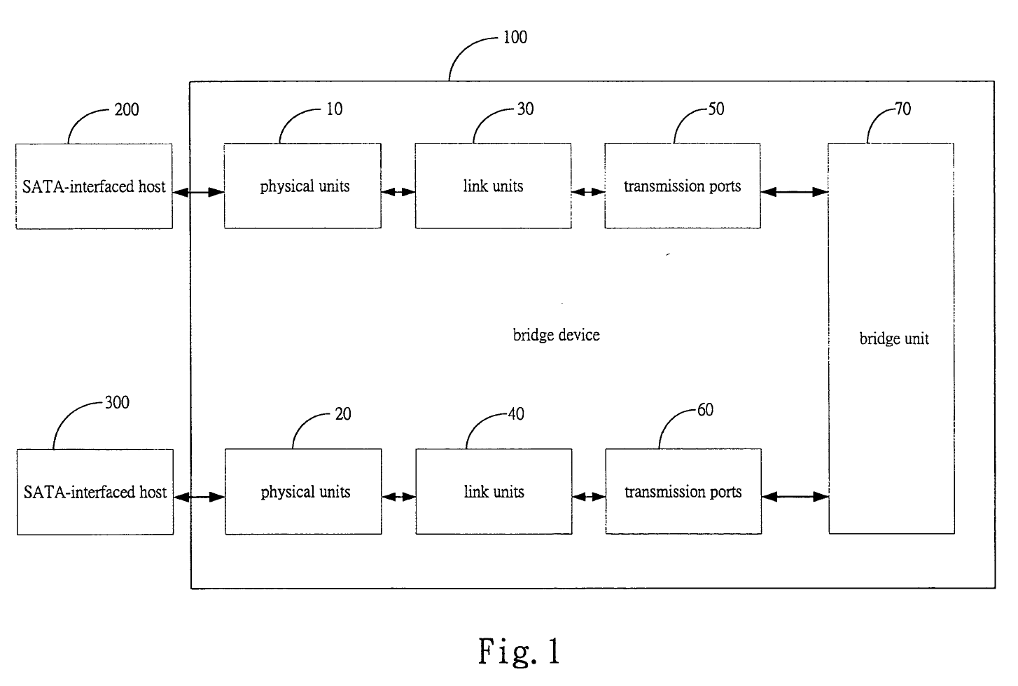

With reference to the drawings and in particular to FIG. 1, which shows a bridge device 100 for SATA-interfaced hosts in accordance with a first embodiment of the present invention, the bridge device 100 comprises a pair of physical units 10, 20, a pair of link units 30, 40, a pair of transmission ports 50, 60, and at least a bridge unit 70. The physical units 10, 20 provide SATA interface electrical signal conversion and connection. The physical unit 10 is connected to a SATA-interfaced host 200, and the physical unit 20 is connected to a SATA-interfaced host 300. The SATA-interfaced hosts 200, 300 are not limited to any specific type. The present invention uses a PC as an example. Other SATA-interfaced hosts, such as notebook PC, game console, are also within the scope of the present invention.

The link unit 30 is connected to the physical unit 10, and the link unit 40 is connected to the physical unit 20. The link units 30, 40 are for encoding and decoding the transmitted and received data so that the SATA-interface data or the signal from the physical units 10, 20 can be encoded or decoded.

The transmission port 50 is connected to the link unit 30, and the transmission port 60 is connected to the link unit 40. The transmission ports 50, 60 are for controlling the host-to-device connection, registers and state of the SATA interface.

The bridge unit 70 is connected to the transmission ports 50, 60. The bridge unit 70 provides the host-to-host data transmission control of SATA interface so that the SATA interface data between the transmission ports 50, 60 can be connected through the bridge unit 70. That is, the SATA-interfaced hosts 200, 300 can directly transmit and receive data.

The bridge unit 70 is not limited to any specific type. This embodiment uses a microprocessor as an example. Other types of equivalent circuit or device are also within the scope of the present invention.

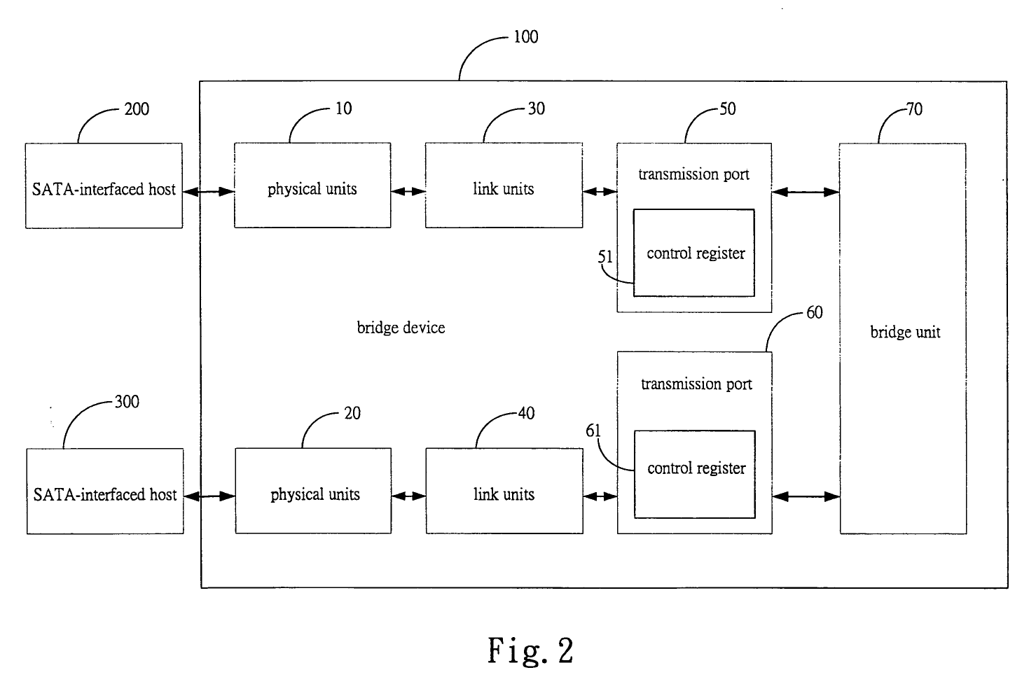

Also referring to FIG. 2, which shows a second embodiment of the bridge device 100 for SATA-interfaced hosts of the present invention, the transmission port 50 includes a control register 51, and the transmission port 60 includes a control register 61. The control registers 51, 61 store the SATA interface control rules for performing the control of SATA host-to-device connection, the register and state of SATA interface.

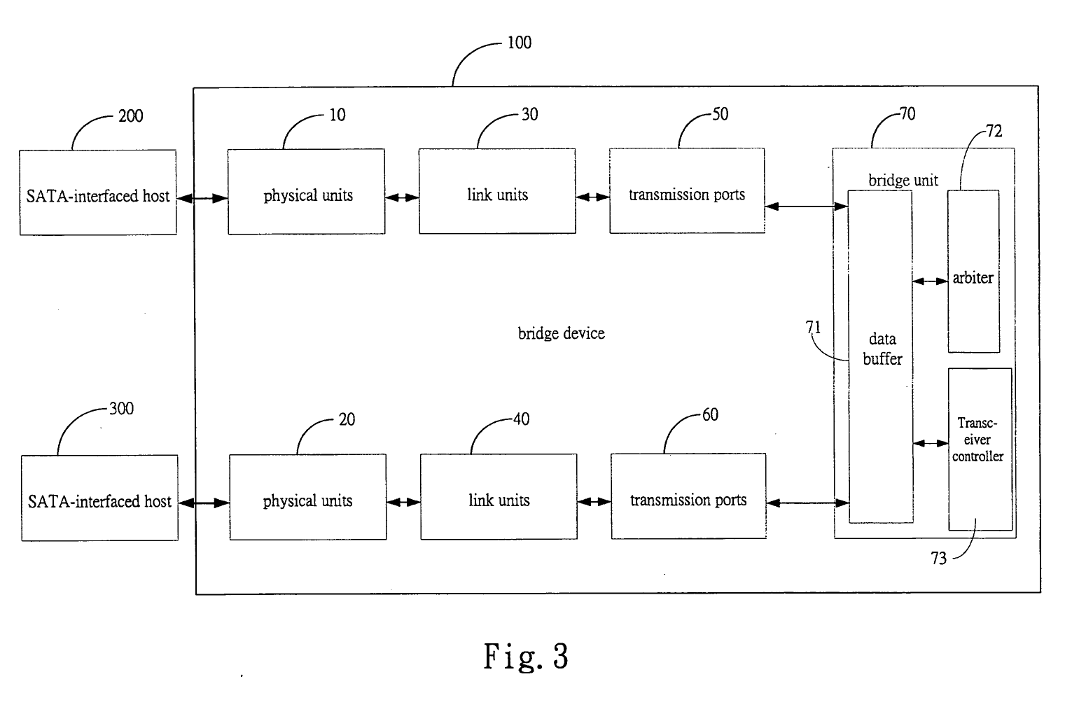

FIG. 3 shows a third embodiment of the bridge device 100 for SATA-interfaced hosts of the present invention. The bridge unit 70 includes a data buffer 71, an arbiter 72, and transceiver controller 73. The data buffer 71 is connected to the transmission ports 50, 60 for buffering the data transmitted between the transmission ports 50, 60, so that the data can be asynchronously FIFO buffered, and accessed at different clock rate.

The arbiter 72 is connected to the data buffer 71 for arbitrating the data access of the transmission ports 50, 60 and the data transmission order of the control registers 51, 61 of FIG. 2.

The transceiver controller 73 is connected to the data buffer 71 for controlling the data transmission and receiving state between the transmission ports 50, 60 according to the state of the data buffer 71. For example, when the data buffer 71 is full, the transmission ports 50, 60 stop transmitting data. When the data buffer 71 is empty, the transmission ports 50, 60 stop receiving data.

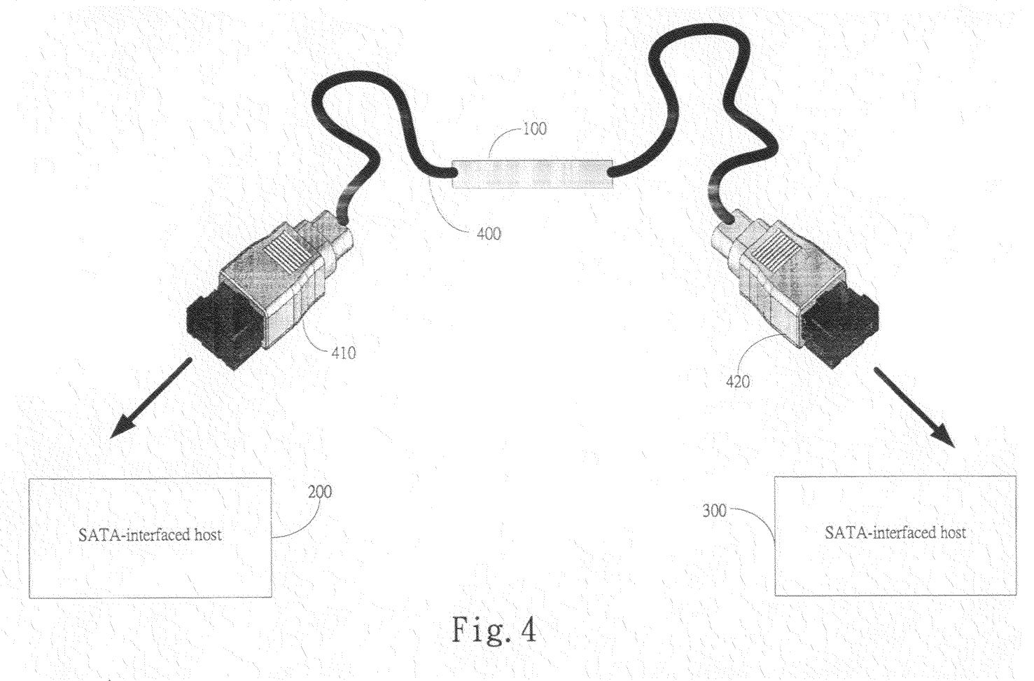

FIG. 4 shows a first application of the present invention. The bridge device 100 is implemented as an IC and embedded in a cable 400. The cable 400 has two ends, with each end having a SATA interface connector 410, 420. The SATA interface connector 410 is connected internally to the physical unit 10 of the bridge device 100, and the SATA interface connector 420 is connected internally to the physical unit 20 of the bridge device 100. The SATA interface connectors 410, 420 are also connected externally to the SATA-interfaced hosts 200, 300, respectively, so that the hosts 200, 300 can directly communicate with each other through the bridge device 100 of the present invention.

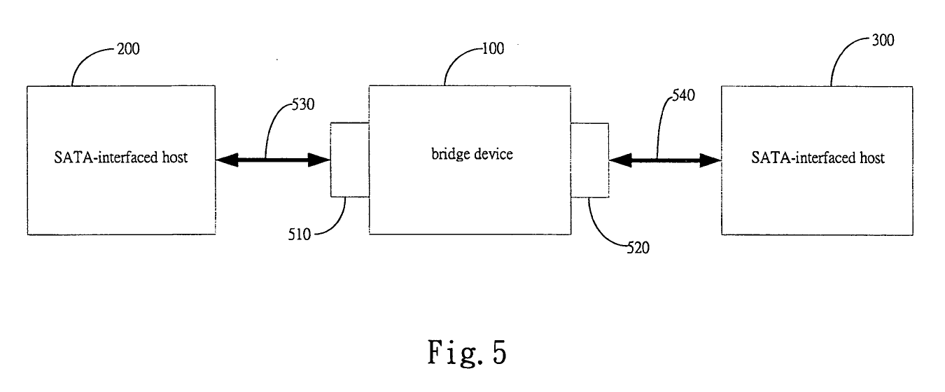

FIG. 5 shows a second application of the present invention. The bridge device 100 of the present invention is implemented as a relay connection device, and the physical units 10, 20 are connected to a SATA interface socket 510, 520, respectively. The SATA interface socket 510 is connected through a SATA interface cable 530 to the host 200, and the SATA interface socket 520 is connected though a SATA interface cable 540 to the host 300. The SATA interface cables 530, 540 are conventional SATA interface host-to-device cables. Similarly, the bridge device of the present invention allows the hosts 200, 300 to communicate directly with each other.

While the invention has been described in connection with what is presently considered to the most practical and preferred embodiments, it is to be understood that the invention is not to be limited to the disclosed embodiment, but on the contrary, is intended to cover various modifications and equivalent arrangement included within the spirit and scope of the appended claims.

What is claimed is:

1. A bridge device for hosts having a SATA interface, THE bridge device comprising:
a pair of physical units, each being connected to a host having a SATA interface for providing SATA interface electrical signal conversion and connection;
a pair of link unit, each being connected to the physical unit respectively for encoding and decoding SATA data and signal from the physical unit;
a pair of transmission ports, each being connected to the link unit, respectively, for controlling SATA interface host-to-device connection and register and state of SATA interface; and
at least a bridge unit, connected to the two transmission ports for controlling host-to-host data transmission of SATA interface so that the hosts are directly communicateable with each other for data and signal transmission.

2. The bridge device as claimed in claim 1, wherein the physical unit is connected to a SATA interface connector.

3. The bridge device as claimed in claim 1, wherein the physical unit is connected to a SATA interface socket

4. The bridge device as claimed in claim 1, wherein the host having a SATA interface connected to the physical unit comprises a personal computer.

5. The bridge device as claimed in claim 1, wherein the transmission port further comprises a control register.

6. The bridge device as claimed in claim 1, wherein the bridge unit comprises:
a data buffer, for buffering data transmitted between the two transmission ports so that data can be asynchronously FIFO buffered and accessed at different clock rates;
an arbiter, connected to the data buffer for arbitrating the data access and transmission order between the two transmission ports; and
a transceiver controller, connected to the data buffer for controlling the data transmission and receiving states of the transmission ports according to the state of the data buffer.

7. The bridge device as claimed in claim 1, wherein the bridge unit comprises a microprocessor.
